(19) United States
(12) Patent Application Publication
(10) Pub. No.: US 2017/0275559 A1
(43) Pub. Date: Sep. 28, 2017

(54) WICKHOLDER WITH SIDE APERTURES, CANDLE PROVIDED THEREWITH AND METHOD FOR PRODUCTION

(71) Applicant: STC GMBH

(72) Inventor: Martien Adriaan VAN DORSSER, Kerekegyhaza (HU)

(21) Appl. No.: 15/534,436

(22) PCT Filed: Dec. 11, 2015
(86) PCT No.: PCT/NL2015/050862

§ 371 Date: Jun. 8, 2017

(30) Foreign Application Priority Data
Dec. 11, 2014 (NL) 2013959
Mar. 27, 2015 (NL) 2014532

(51) Int. Cl. C11C 5/00; F23D 3/24

(52) U.S. Cl. CPC C11C 5/006; F23D 3/24

(57) ABSTRACT

The invention relates to a wick holder, a candle provided therewith and a method for providing such a wick holder for a candle. The wick holder according to the invention comprises: —a base sheet; —an opening arranged in the base sheet, wherein the opening is provided on a side of the base sheet facing upward during use with a sleeve-like body for receiving the wick; and —wherein in the sleeve-like body is arranged at least one side opening configured to allow passage of liquid candle material during use.

The present invention relates to a wick holder for a candle and candle-like objects. Such a wick holder is applied particularly in so-called tealights and in other candles and candle-like objects such as glass candles, grave candles, block candles and other candles wherein a wick is fixed by a wick holder.

A metal, glass, ceramic or plastic casing is provided in the tealights known in practice. A candle in the form of a filling, for instance as a tablet or as hot filling, is arranged in the casing. The candle is provided with a wick which is fixed on the underside of for instance a tablet by the wick holder. The wick holder is provided here with a base sheet in which an opening is arranged for the wick. During use the filling becomes liquid because of the heat and the wick holder ensures that the wick does not begin to float. The wick is usually secured in the wick holder, for instance by fixedly clamping the wick.

EP 2361962 and WO 03/064921 show such conventional wick holders for a candle.

Problems occurring in practice with conventional wick holders (and candles) are a less than optimal burning. This is caused for instance in that insufficient liquid candle material can be drawn up by the wick. This occurs for instance because, when the wick holder is adhered in a holder, glue as it were clogs the wick and can hereby even bring about an undesired adhesion of the wick to or in the wick holder.

The object of the present invention is to provide a wick holder which obviates or reduces the above stated problems.

This object is achieved with the wick holder according to claim 1.

The wick holder according to the invention is provided with a base sheet with a preferably central opening in which or on which a sleeve-like body is provided on a side of the base sheet for receiving the wick. This side is particularly the side of the base sheet facing upward during use. The wick is better held at the desired position and in the desired direction by the sleeve-like body. The sleeve-like body is preferably provided with a round cross-section, although other shapes are also possible, including for instance an oval or rectangular shape or an elongate (ribbon) shape for a flat wick. The sleeve-like body has for instance a length (height) of about 3-10 mm, wherein a greater length is for instance advantageous when placing a candle provided with the wick holder according to the invention in a glass holder. A greater height/length of the wick holder, in particular the sleeve-like body, prevents the flame coming too close to the bottom during use. Cracking or breaking of such a holder or melting of an alternative plastic holder and other problems are hereby prevented. It will be apparent that other dimensions are also possible for the sleeve-like body and the wick holder according to the invention.

Providing at least one side opening brings about lateral inflow of liquid candle material on the upper side of the base sheet. This results in a “side flow” wick holder. The wick need not hereby draw up all the liquid candle material from the underside of the base sheet during use. This achieves that supply of liquid candle material to the wick is also better guaranteed and/or guaranteed for longer if the underside of the base sheet were to become blocked, for instance due to undesired clogging of the wick by the glue. Candles hereby burn better and/or for longer, also because for instance more wax can burn. Also when the wick is relit the supply is improved because of the side openings such that the wick is prevented from burning when sufficient candle material has not (yet) become liquid. The supply of liquid candle material, such as wax, is possible sooner through a side opening when the wick is relit. The wick will hereby burn less quickly. The larger the base sheet becomes, the greater this problem becomes in conventional wick holders. This is avoided by providing side openings according to the invention.

A better flow to the wick is therefore provided by configuring the side opening such that liquid candle material can flow laterally into the wick holder above the base sheet during use. The side openings can be provided as holes, recesses, incisions and the like. The side openings are preferably arranged in or close to the sleeve-like body and in or close to the base sheet, preferably at the transition from sleeve-like body to base sheet. It has been found that an effective supply of liquid candle material to the wick in the wick holder is realized in practice at such a position. Owing to the side openings, supply of liquid candle material to the wick is even provided when the base sheet is at an incline.

In a currently preferred embodiment the side openings are provided as incisions. The incisions are preferably arranged during deep-drawing without material having to be removed, as would for instance be the case if drilled holes were arranged. The production of the wick holder with side openings is hereby simplified, and modifications to conventional production lines can remain limited.

Two or more, preferably three to eight, side openings are preferably provided. Providing a plurality of side openings, preferably around the sleeve-like body in which the wick is situated during use, achieves that the wick is provided in effective manner with liquid candle material as circumstances require. Possible clogging or even undesired adhesion of the wick in or to the wick holder hereby no longer automatically results in a poorly functioning candle. For conventional wick holders this is increasingly an issue in the case of smaller base sheets. Sufficient liquid candle material can nevertheless be supplied in such a case because of the side openings according to the invention.

In a currently preferred embodiment according to the invention the wick holder comprises an additional fold line arranged at or close to the transition from base sheet to the opening, such that deformation of the base sheet during clamping of the wick in the wick holder is prevented.

Said additional fold line is preferably applied in embodiments according to the invention. Such an additional fold line can optionally be dispensed with. This does however mean that the thereby gained advantages are not achieved.

A further problem occurring in practice is the deformation of the base sheet in conventional wick holders. This can for instance result in a non-flat or less flat base sheet. Positioning and/or adhesion for instance of the wick holder is hereby more difficult. The production process hereby becomes more complex or more difficult, and possibly even more costly, with more products being rejected. Because of the non-flat base sheet, the base sheet no longer functions properly, which for instance results in the wick being askew and/or whereby the burning time of the candle is reduced.

Providing an additional fold line according to the present invention achieves that the base sheet does not deform, or hardly so, when the wick is fixed in the holder by exerting a clamping force. Preventing deformation of the base sheet guarantees proper operation of the base sheet. This has the result, among others, of a good adhesion quality, wherein the wick will not displace from the centre. In addition, the wick remains via the opening in contact with the candle material which is preferably liquid during use, for instance wax material. The burning time or burning duration of the candle is hereby maintained. The wick holder also remains more stable during use, whereby the wick stands straighter or vertically during use, and remains in this position more readily during use, whereby the appearance of the candle is enhanced and/or better maintained during use.

An additional advantage of providing the additional fold line is that, as a result of deformation of the base sheet being prevented, the base sheet can be given smaller dimensions. The base sheet can thus particularly be given a smaller diameter, whereby the amount of material used for the wick holder of the candle can be reduced. It has thus been found that a reduction in diameter of a conventional base sheet from about 15 millimetres to about 12-13 millimetres is possible, with an associated cost-saving, based on a material-saving, of for instance about 20%. It has been found that deformation is counteracted or can even be avoided at any diameter of the base sheet of the wick holder by providing an additional fold line. Diameters of the base sheet amount to for instance 12, 15, 20, 30, 40 and even 80 millimetres. It is noted that other diameters and other shapes, for instance square, oval, strip-like and so on, are likewise possible.

A further advantage resulting from the reduction of the diameter of the base sheet when deformation of the base sheet is prevented is that the amount of residual material, including the wick holder, remaining after use of the candle is likewise reduced.

The insertion of a wick into the wick holder according to the invention can also be performed more easily in practice. This provides advantages in the processing of the wick holder.

At least a part of the side openings is preferably arranged in the additional fold line. The most optimal possible supply of material in the direction of the wick is hereby achieved.

In an advantageous preferred embodiment according to the present invention the additional fold line is provided with a radius of curvature for the inner side in the range of 0.25-4.0 millimetres, preferably in the range of 0.25-3.0 millimetres, more preferably in the range of 0.5-1.0 millimetre, and most preferably amounts to about 0.6 millimetre.

It has been found that by applying a radius of curvature for the inner side of the additional fold line in the above stated ranges, preferably about 0.6 millimetre, a good transmission of force is realized such that deformation of the base sheet is prevented. The corresponding outer radius is about 0.2 millimetre larger.

In a currently preferred embodiment the transition between the base sheet and the sleeve-like body comprises two or more, preferably three, transitions with an individual radius of curvature. The radius of curvature between base sheet and additional fold line is thus for instance about 0.3-1.5 millimetre, preferably 0.3-0 5 millimetre, as is the radius of curvature for the transition between additional fold line and the sleeve-like body. The radius of curvature is seen here from the inner side of the opening. The radius of the outer side preferably lies in the range of 0.1-1.3 millimetre, preferably 0.1-0.3 millimetre. As already mentioned above, the radius of curvature of the additional fold line amounts for instance to about 0.6 millimetre, as seen from the inner side, while the outer radius amounts to about 0.8 millimetre. It has been found that deformation of the base sheet is hereby prevented in effective manner. One or more additional fold lines can optionally be provided.

Additional (drilled) holes can optionally be further provided in the base sheet in order to make possible for instance a flow of liquid candle material from the underside to the upper side of the base sheet. The opening and/or base sheet can optionally also have shapes other than round, for instance oval or rectangular.

It has been found that the combination of providing an additional fold line and side openings provides an optimal performance of the candle. A good supply of liquid candle material to the wick is brought about here under substantially all conditions occurring in practice. It has been found that this result can be achieved even if the wick has not been correctly fixed to the wick holder.

The present invention further relates to a candle or candle-like object provided with a wick holder as described above.

Such a candle provides the same effects and advantages as described above in respect of the wick holder. Such candles are for instance tealights, glass candles, grave candles, block candles and other candles or candle-like objects wherein a wick is fixed by a wick holder.

The invention further also relates to a method for providing a wick holder for a candle or candle-like object according to claim 9.

Such a method provides the same effects and advantages as described above for the wick holder and/or candle provided therewith. Within the context of the invention sheet is understood to mean, among others, sheet, band, strip, foil and so on.

In order to provide a candle a candle wick is preferably arranged in the opening of the wick holder. The wick is preferably secured in the wick holder here, for instance by local deformation such as clamping.

In a currently preferred embodiment the securing of the wick in the wick holder comprises of clamping the wick in the wick holder. This clamping is for instance performed by locally compressing the sleeve-like body at one or more positions, or all the way or some of the way around. It has been found that by providing the above stated additional fold line or fold lines deformation of the base sheet substantially does not occur at all or is at least significantly reduced compared to the production of conventional wick holders. This achieves that it is possible to suffice with a base sheet of a smaller size and/or that the quality of the wick holder is increased. This for instance reduces the use of sheet material for a wick holder in a candle.

In a currently preferred embodiment according to the invention the one or more side openings are arranged in the wick holder by deep-drawing. It is possible here to provide a number of holes or openings, after which the deep-drawing is performed, wherein the desired side openings are realized during the deep-drawing. This has the advantage that no separate (final) processing steps, such as a drilling step, are necessary for the manufacture of the wick holder according to the invention. An effective manufacturing process for the wick holder is hereby provided.

Further advantages, features and details of the invention are elucidated on the basis of the preferred embodiments thereof, wherein reference is made to the accompanying drawings, in which:

FIG. 1 shows a view of a wick holder according to the invention;

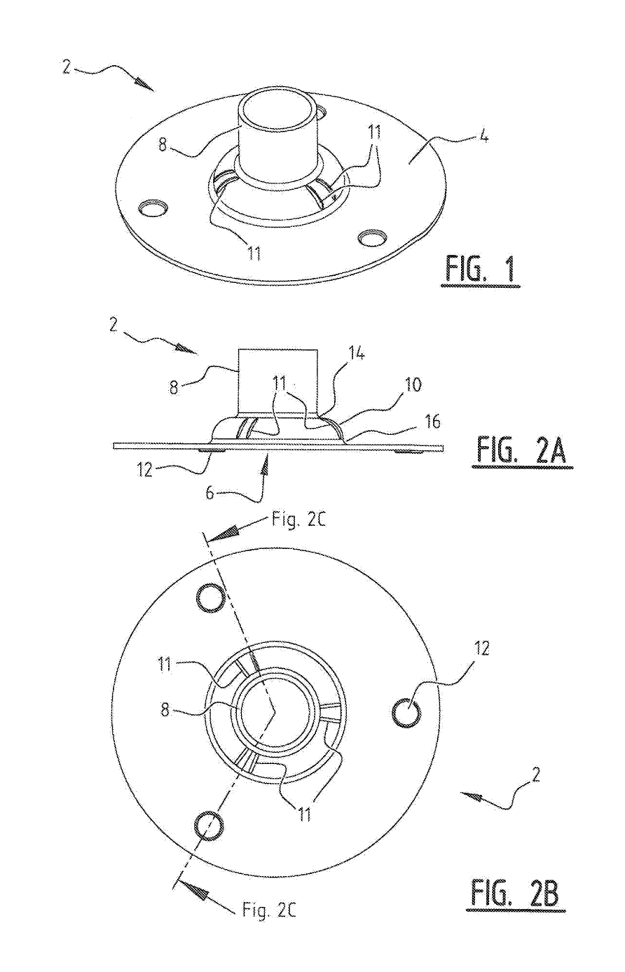

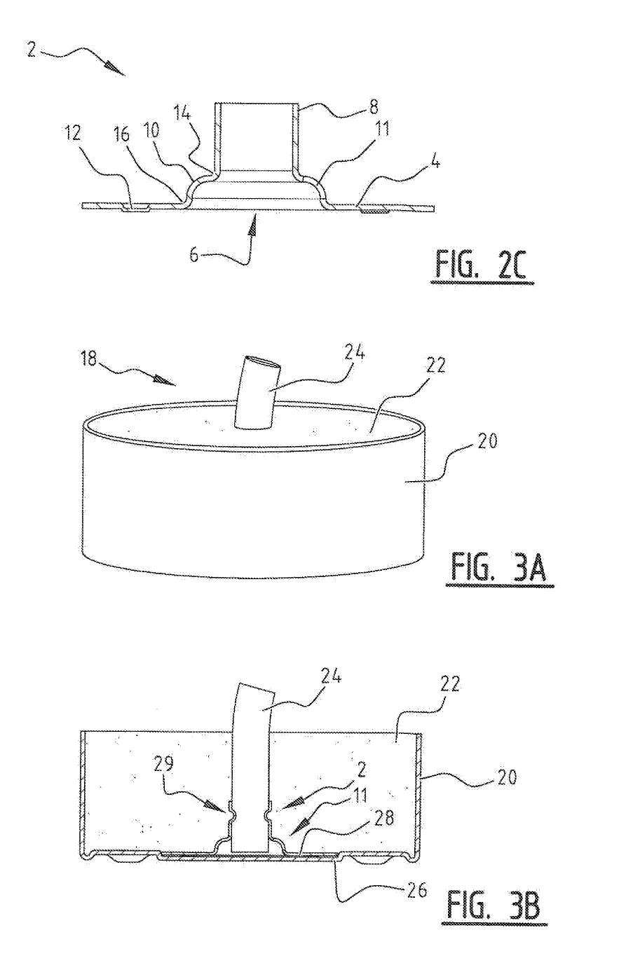

FIGS. 2A-C show views and a cross-section of the wick holder of FIG. 1;

FIGS. 3A-B show a view and a cross-section of a candle provided with the wick holder of FIG. 1;

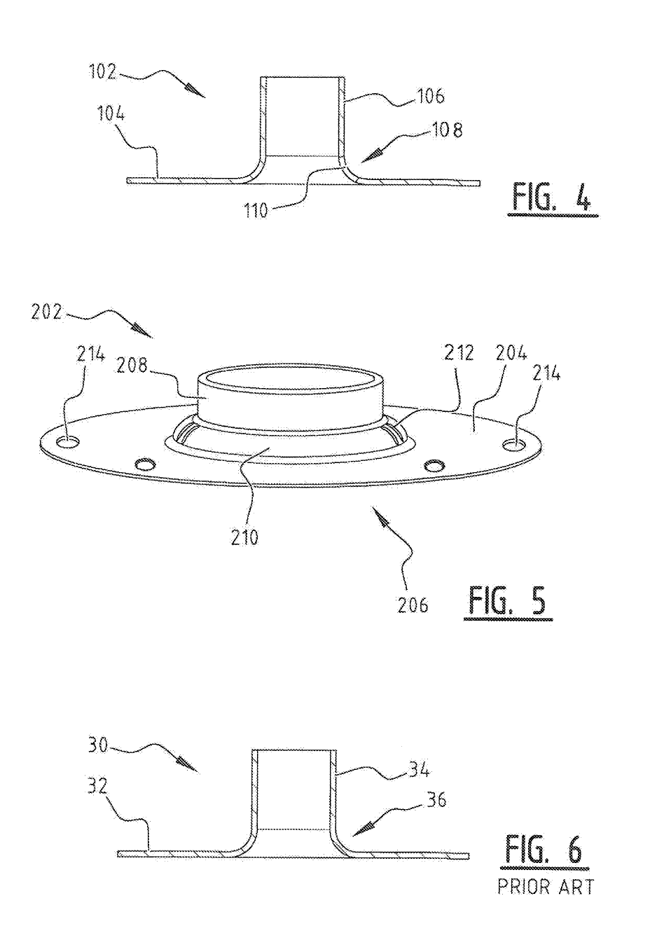

FIG. 4 shows a view of an alternative embodiment without fold line;

FIG. 5 shows a view of a further alternative embodiment according to the invention;

FIG. 6 shows a view of a conventional wick holder;

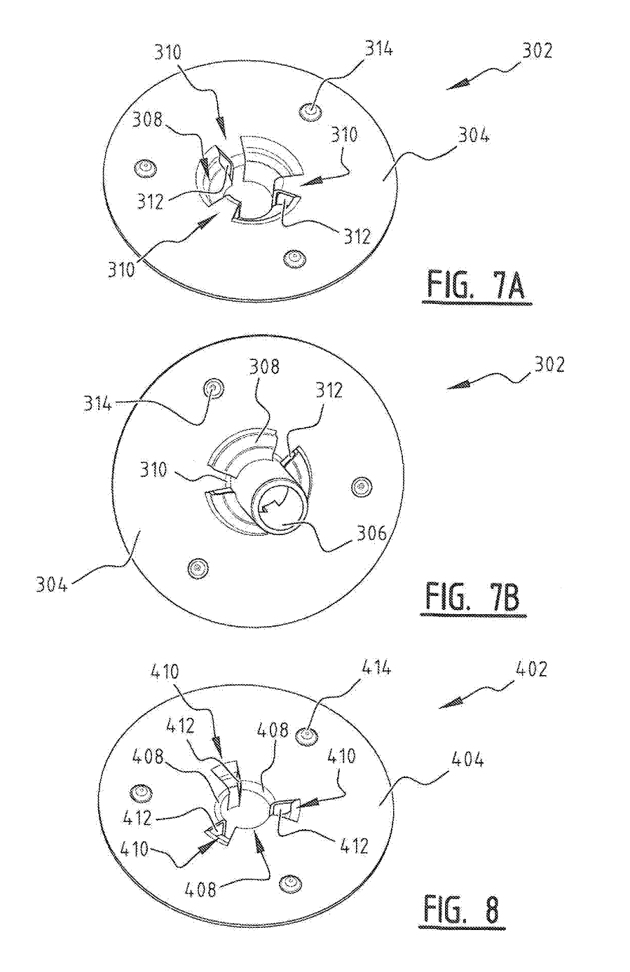

FIGS. 7A-B show views of a further embodiment according to the invention;

FIG. 8 shows a view of a further alternative embodiment according to the invention; and

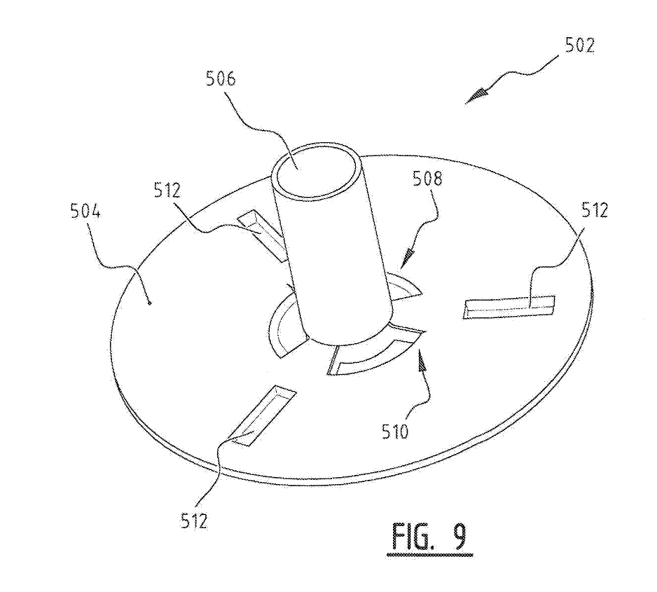

FIG. 9 shows a view of yet another alternative embodiment according to the invention.

Wick holder 2 (FIG. 1) is provided with base sheet 4, opening 6 and sleeve 8 for receiving a wick. Fold line 10 in the form of an additional edge is provided between base sheet 4 and sleeve 8.

Fold line 10 is also provided with opening 11. In the shown embodiment holder 2 is provided with three groups or pairs, each of two openings 11 in the form of incisions. It will be apparent that a different number of openings and/or a different shape are also possible according to the invention.

In the shown embodiment wick holder 2 (FIGS. 2A-C) is provided with feet 12 embodied in the form of protrusions. Protrusions 12 provide for a capillary action during use such that the wick is fed from below with the liquid material of the candle. Sleeve 8 is further connected via first transition 14 to fold line 10, and then via second transition 16 to base sheet 4.

In the shown embodiment base sheet 4 is provided with a thickness of about 0.15-0.25 millimetre and a diameter of about 12.5 millimetres. It will be apparent that material thicknesses can vary, for instance from 0.10-2 mm, preferably 0.15-1 mm. It will further be apparent that within the context of the invention sheet material should be understood to mean, among others, sheet, strip, foil and band, manufactured from diverse possible materials including steel, aluminium, brass and refined steel, such as galvanized, tin-plated or chrome-plated. Plastic material such as polycarbonate can optionally also be used as starting material, for instance in an injection moulding process. It is possible here to manufacture the wick holder and the holder as a single part. The outer radius for first and second transitions 14, 16 is about 0.4 millimetre and the inner radius about 0.2 millimetre. Corresponding values for fold line 10 amount to respectively 0.8 and 0.6 millimetre. The diameter of opening 6 amounts to about 3 millimetres and the inner diameter of sleeve 8 amounts to about 2.6 millimetres. It will be apparent that said dimensions can vary. In many embodiments the inner diameter of sleeve 8 thus lies in the range of 1.6 to 6 mm.

Candle 18 (FIGS. 3A-B) is provided with container 20 in which a filling 22 is arranged, or wherein container 20 is fillable in other manner with candle material. Container 20 is provided with wick 24 with wick holder 2. Space 28 is provided between the underside of base sheet 4 and bottom 26 of container 20 by protrusions 12. Space 28 is filled during use with liquid candle material. Wick 24 is clamped in sleeve 8 by deformation 29. Deformation 29 can be applied at one or more points, or even all the way around.

Wick holder 102 (FIG. 4) is provided with base sheet 104, sleeve 106 and transition or curvature 108. A number of openings 110, in the shown embodiment preferably embodied as incisions, are provided in or close to curvature 108. Wick holder 102 is therefore not provided with an additional fold line.

Alternatively formed wick holder 202 (FIG. 5) is provided with base sheet 204 with opening 206 and holder 208. In the shown embodiment base sheet 204, opening 206 and holder 208 are provided with an oval shape. It will be apparent that other shapes are likewise possible according to the invention. Side openings 212 are also provided, preferably in or close to fold line 210. Further provided in the shown embodiment in addition to feet (elements 12 in FIGS. 1 and 2) are optional drilled holes 214 which enable flow of liquid candle material from the underside to the upper side of base sheet 204.

Conventional wick holder 30 (FIG. 6) is provided with base sheet 32, sleeve 34 and a single transition 36. Such a conventional wick holder is for instance shown in EP 2361962.

Wick holder 302 (FIGS. 7A-B) is provided with base sheet 304, sleeve 306 for receiving a wick, and additional fold lines 308. Three bridge parts 310 are arranged in the shown embodiment by omitting fold line 308 at these positions. Side openings 312 are arranged here on substantially the sides of parts 310 in order to make supply of wax to the wick possible from the side. Three feet 314 are also provided in the shown embodiment.

An alternative wick holder 402 (FIG. 8) is provided with a base sheet 404, sleeve 406 for receiving a wick and a fold line 408 which is reversed relative to the above discussed variant of wick holder 302. Alternative wick holder 402 is also provided with side openings 412 on sides of parts 410. Openings 412 function as additional supply of wax to the wick. Feet 414 are also provided.

A further alternative wick holder 502 (FIG. 9) is provided with base sheet 504, sleeve 506 for receiving a wick, and a fold line 508 shaped in reverse and lying in the side of base sheet 504 facing downward during use. Side openings 510 on the underside of base sheet 504 provide for additional supply of wax to the wick. Additional feet, for instance in the form of grooves 512, are optionally arranged in order to enhance the support function. Additional side openings can be provided if desired on the upper side of base sheet 504.

It will be apparent that diverse aspects of a shown embodiment can be applied in another embodiment which may or may not be shown. The shape of side openings 11, 312, 412 can also be varied.

Use is preferably made of a sheet material for the production of wick holder 2, 202, 302, 402 according to the invention. Wick holder 2 is then given the desired shape, preferably with fold line 10 and openings 11, in a number of process runs. The sheet material is pressed here into a shell or mould of the desired shape. Wick 24 is then arranged in sleeve 8. In the shown embodiment sleeve 8 is then pinched or deformed by heat, whereby wick 24 is secured to wick holder 2. Forces are optimally transmitted by fold line 10 during this clamping such that no significant deformation of base sheet 4 occurs.

The present invention is by no means limited to the above described embodiments thereof. The rights sought are defined by the following claims, within the scope of which many modifications can be envisaged. It is thus possible to provide a plurality of fold lines 10 so as to thereby further improve force transmission and further prevent deformation of base sheet 2. Grooves or notches, which are preferably provided integrally with base sheet 4, can be provided in addition or as alternative to protrusions 12.

1. Wick holder for a candle, comprising:
a base sheet;
an opening arranged in the base sheet, wherein the opening is provided on a side of the base sheet facing upward during use with a sleeve-like body for receiving a wick;
wherein in the sleeve like body is arranged at least one side opening configured to allow passage of liquid candle material during use; and
a fold line in the form of an additional edge arranged close to the transition from base sheet to the opening such that deformation of the base sheet during clamping of the wick in the wick holder is prevented.

2. Wick holder as claimed in claim 1, wherein the side opening is configured to allow liquid candle material to flow above the base sheet laterally into the wick holder during use.

3. Wick holder as claimed in claim 1, wherein two or more, preferably three to eight, side openings are provided.

4. Wick holder as claimed in claim 1, wherein at Least a part of the side openings is arranged in the additional fold line.

5. Wick holder as claimed in claim 4, wherein the fold line is provided with a radius of curvature in the range of 0.25-4.0 millimetres, preferably in the range of 0.25-3.0 millimetres, more preferably in the range of 0.5-1.0 millimetre, and most preferably amounts to about 0.6 millimetre.

6. Wick holder as claimed in claim 5, wherein the transition between the base sheet and the sleeve-like body comprises at least two transitions with an individual radius of curvature.

7. Wick holder as claimed in claim 6, wherein the transition comprises three transitions.

8. Candle provided with a wick holder as claimed in claim 1 in which a wick is arranged.

9. Method for providing a wick holder for a candle, comprising the steps of: supplying a sheet of starting material; and deforming the sheet in order to form a wick holder as claimed in claim 1.

10. Method as claimed in claim 9, further comprising arranging the wick in the opening and securing the wick in the wick holder.

11. Method as claimed in claim 10, wherein the securing of the wick in the wick holder comprises clamping the wick in the wick holder.

12. Method as claimed in claim 9, further comprising the step of deep-drawing the wick holder such that at least one side opening is created.
